(19) United States
(12) Patent Application Publication
(10) Pub. No.: US 2024/0289818 A1
(43) Pub. Date: Aug. 29, 2024

(54) FEATURE STORE DATA PREPARATION OPTIMIZATION

(71) Applicant: Microsoft Technology Licensing, LLC, Redmond, WA (US)

(72) Inventors: Jesus CAMACHO RODRIGUEZ, Sunnyvale, CA (US); Kwanghyun PARK, Kirkland, WA (US); Fotios PSALLIDAS, Brooklyn, NY (US); Xiaoyong ZHU, Issaquah, WA (US); Jinghui MO, Wellesley, MA (US); Rathijit SEN, Redmond, WA (US); Matteo INTERLANDI, Torrance, CA (US); Yuanyuan TIAN, San Jose, CA (US); Rui LIU, Chicago, IL (US); Konstantinos KARANASOS, San Francisco, CA (US)

(21) Appl. No.: 18/332,118

(22) Filed: Jun. 9, 2023

Related U.S. Application Data
(60) Provisional application No. 63/487,490, filed on Feb. 28, 2023.

(51) Int. Cl. G06Q 30/0201; G06N 20/00

(52) U.S. Cl. CPC G06Q 30/0201; G06N 20/00

(57) ABSTRACT

The described technology provides a method including receiving a new feature definition; the new feature definition specifying parameters of the feature, comparing the new feature definition with a plurality of computed feature definitions stored in a feature store, and in response to determining that the new feature definition is at least partially contained in a matched feature definition of the plurality of computed feature definitions, generating an alternative feature definition based on the new feature definition and the matched feature definitions, and selecting an execution alternative from an execution of a PIT join using the alternative feature definition and an execution of a PIT join using the new feature definition.

### CROSS REFERENCE TO RELATED APPLICATIONS

This application is a non-provisional application based on and claims benefit of priority to U.S. provisional patent application No. 63/487,490 filed on Feb. 28, 2023, and entitled feature store data preparation optimization, which is incorporated herein by reference in its entireties.

### BACKGROUND

It is common for modern organizations to deploy hundreds if not thousands of machine learning (ML) models to power applications such as search, recommendation systems, advertising placement, etc. Feature engineering, which consists of pipelines that transform data from multiple sources into feature values due to different domain knowledge, is an important step in building these ML applications. However, it can be time-consuming for data engineers and scientists. In addition, implementing ad-hoc pipelines may work for specific model development and deployment but can become impractical as the number of models scales. For example, significant domain knowledge is required to correctly calculate features for some models but maybe not for others. Furthermore, improperly implemented pipelines can result in correctness issues that cause a decrease in the accuracy of the ML models being deployed.

### SUMMARY

The described technology provides a method including receiving a new feature definition; the new feature definition specifying parameters of the feature, comparing the new feature definition with a plurality of computed feature definitions stored in a feature store, and in response to determining that the new feature definition is at least partially contained in a matched feature definition of the plurality of computed feature definitions, generating an alternative feature definition based on the new feature definition and the matched feature definitions, and selecting an execution alternative from an execution of a PIT join using the alternative feature definition and an execution of a PIT join using the new feature definition.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Other implementations are also described and recited herein.

### BRIEF DESCRIPTIONS OF THE DRAWINGS

FIG. 1 illustrates an example implementation of a processing of time-series data by the feature store data preparation optimization technology disclosed herein.

FIG. 2 illustrates an example data sources that may be used by the feature store data preparation optimization technology disclosed herein.

FIG. 3 illustrates an example point-in-time join used to compute an aggregate feature according to the feature store data preparation optimization technology disclosed herein.

FIG. 4 illustrates example workflow for feature extraction according to the feature store data preparation optimization technology disclosed herein.

FIG. 5 illustrates example workflow for data layout selection according to the feature store data preparation optimization technology disclosed herein.

FIG. 6 illustrates an example system that may be useful in implementing the feature store data preparation optimization technology disclosed herein.

### DETAILED DESCRIPTIONS

Feature stores are relatively new in the world of data management. While they are considered a cornerstone to address many of the challenges present in feature engineering, there still exist untapped opportunities to reduce the time and resources consumed by this task in existing feature store implementations. It is common for modern organizations to deploy hundreds if not thousands of machine learning (ML) models to power applications such as search, recommendation systems, advertising placement, etc. Feature engineering, which consists of pipelines that transform data from multiple sources into feature values due to different domain knowledge, is an important step in building these ML applications. However, it can be time-consuming for data engineers and scientists. In addition, implementing ad-hoc pipelines may work for specific model development and deployment but can become impractical as the number of models scales. For example, significant domain knowledge is required to correctly calculate features for some models but maybe not for others. Furthermore, improperly implemented pipelines can result in correctness issues that cause a decrease in the accuracy of the ML models being deployed.

Implementations of the described technology provides various methods to enable more effective and efficient data management processes for utilization of feature stores (FSs). Implementations of the FSs disclosed herein allows users to create sophisticated computation pipelines for transforming raw data into relevant features. These pipelines may consist of multiple stages and enable the combination of features to compute even more complex features, providing the necessary flexibility to generate the datasets required by ML models. For example, FSs disclosed herein may be utilized to handle time series data, providing APIs and operations that simplify the processing of such data while guaranteeing point-in-time accuracy and correctness. Example implementation of the FS uses point-in-time (PIT) join operation to generate training data with PIT accuracy guarantee to represent combined data reflecting the state of the data sources at the desired point in time.

Specifically, the implementations disclosed herein discloses novel reuse-based optimization techniques for feature computation pipelines containing PIT joins, one of the most crucial operations in feature stores, along with an effective cost model based on sketches algorithms that read and create complex representation of, for example, previous pipelines, to select the most performant execution plans. Additionally, the implementations disclosed herein also provide a data layout selector that relies on binary integer linear programming to choose the best global configuration for the feature store data sources according to the provided cost function.

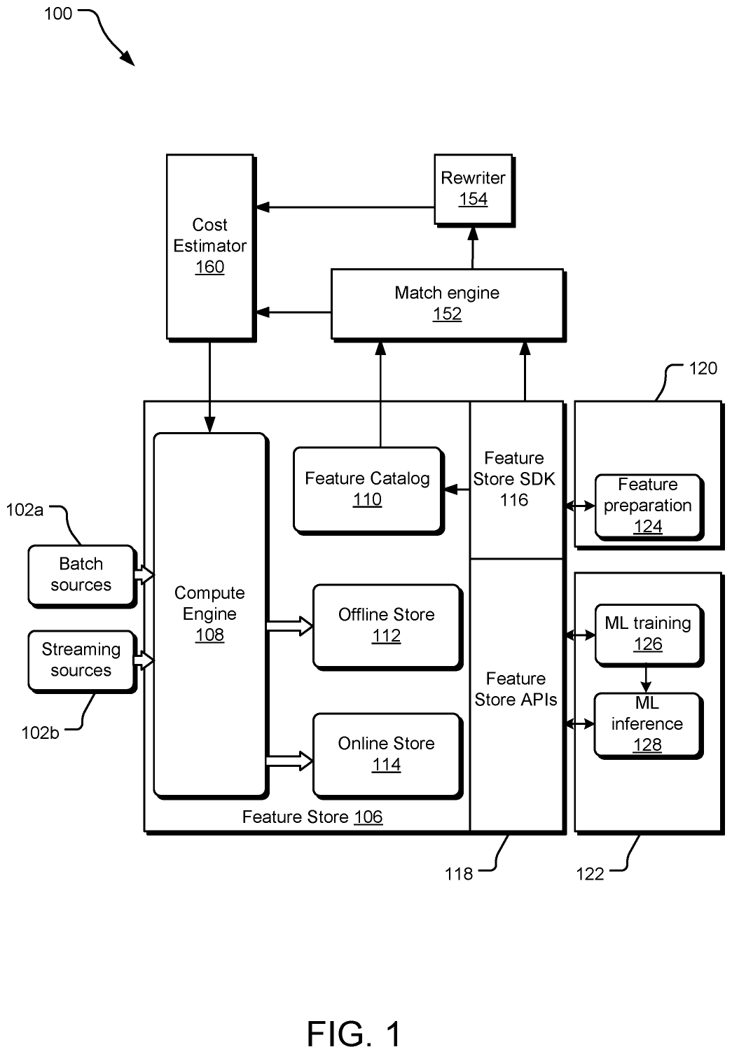

FIG. 1 illustrates an example implementation of a feature store (FS) data preparation optimization system 100 employing the FS data preparation optimization technology disclosed herein. The system 100 may include a FS 106 employing a PIT join operation to generate training data from data sources 102. For example, the data sources 102 may include one or more batch data sources 102a and a one or more streaming data sources 102b. The batch data source 102a may provide data to the FS 106 on a periodic basis, such as hourly, daily, monthly, etc. For example, for the FS 106 for retail data, the sales data for periods of time may be sent to the FS 106. On the other hand, the streaming data sources 102b may provide data to the FS 106 on a streaming basis as data is produced. For example, for the FS 106 for investment data, as the market data is generated, it may be streamed to the FS 106.

The FS 106 may include a compute engine 108 that is configured to execute transformations on the incoming data. The compute engine 108 may be a throughput optimized multi-language engine for executing data engineering, data science, and machine learning on single-node machines or clusters of nodes. The compute engine 108 may have built-in pipeline or transformation algorithms to generate the output data. Alternatively, the compute engine may also execute one or more pipelines or transformation algorithms provided by users on the incoming data. Specifically, the compute engine 108 processes the incoming data using these algorithms to generate output that is stored in an offline store 112 or an online store 114.

The offline store 112 may store data that is used by a machine learning (ML) engine 122. The ML engine 122 may include an ML training engine 126 and an ML inference engine 128. The ML training engine 126 may retrieve data from the offline store 112 as needed to train an ML model. For example, the ML training engine 126 may retrieve data from the offline store 112 regarding retail purchases by a large number of consumers over a period of time and train and retrain the ML model. On the other hand, the ML inference engine 128 may retrieve data from the online store 114 to generate inferences using the trained ML model. Thus, for example, the ML inference engine 128 may retrieve current data about an online user and input the data into the trained ML model to draw inferences about potential purchase patterns of the online user. Therefore, the online store 114 may be optimized for latency. The ML engine 122 may interact with the online store 112 and the offline store 114 using one more more feature store APIs 118.

The FS 106 may also have a feature catalog 110 that is configured as a registry of metadata about the definition of the pipelines being executed by the compute engine 108. For example, the feature catalog 110 may store descriptions of the pipelines, the project, user, or organization that a certain pipeline belongs to, feature definitions of each of the pipelines, etc. One or more users 120, such as data engineers, may interact with the feature catalog 106 using an FS software development kit (SDK) 116 as well as using the FS APIs 118. For example, the user 120 may use a feature preparation engine 124 to provide definitions and or metadata to the FS SDK 116.

The FS SDK 116 significantly simplifies the process of creating complex feature computation pipelines for the users 120. The illustrated implementation of the FS data preparation optimization system 100 also includes a match engine 152 that is configured to compare a new feature definition received from the SDK 116 with one or more existing and computed feature definitions that may be stored int the feature catalog 110. If the match engine 152 determines that the new feature definition is at least partially contained in a matched feature definition of the feature catalog 110, a rewriter 154 generates an alternative feature definition based on the new feature definition and the matched feature definitions.

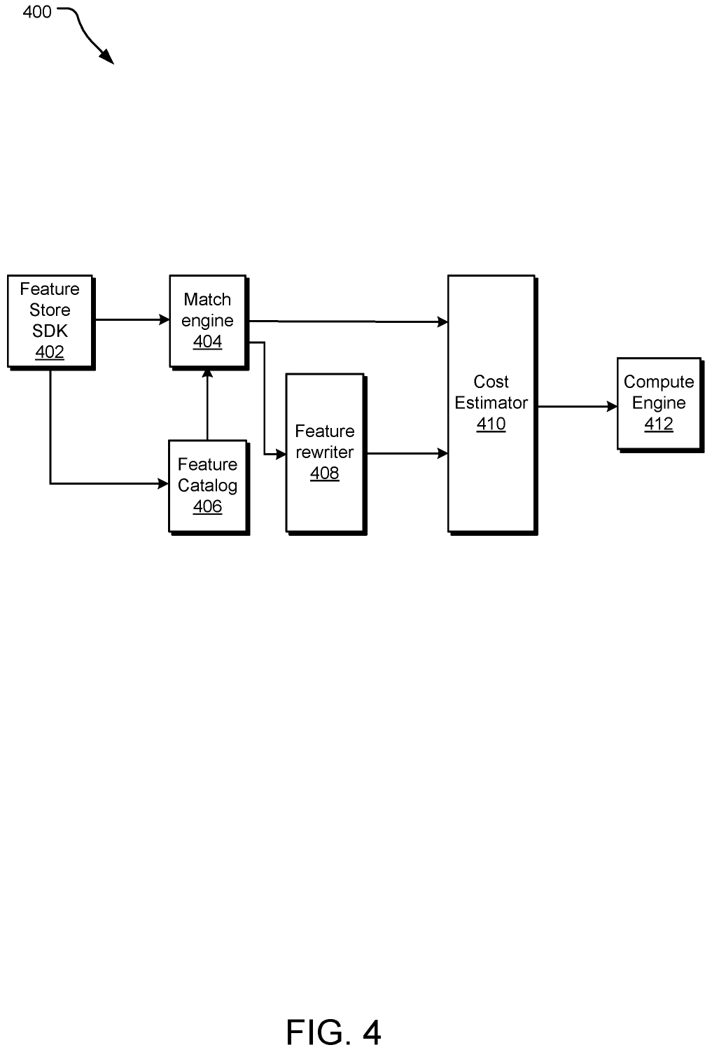

One or more of the alternative feature definitions, and the new feature definitions are input into a cost estimator 160. The cost estimator 160 selects an execution alternative from one or more of the alternative feature definitions and the new feature definition. The functioning of the match engine 152, the rewriter 154, and the cost estimator 160 are disclosed in further detail below with respect to FIG. 4.

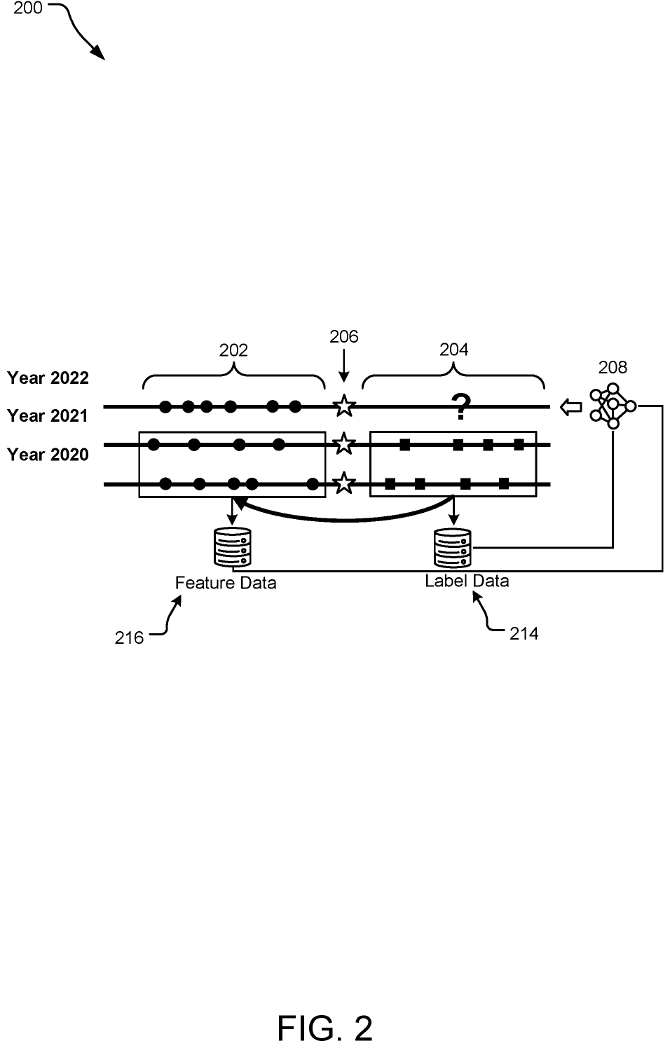

FIG. 2 illustrates an example data sources 200 that may be used by the feature store data preparation optimization technology disclosed herein. Specifically, the data sources 200 may be for data of an e-commerce site that wants to predict whether a customer will buy a certain item during Labor Week 2022. The resulting two data sources includes a label source dataset 214 containing whether a user bought item a in Labor Week 2020 and 2021, and a feature source dataset 216 with the purchase amount by each user on a given day.

Here one possible option is to make this prediction based on what a customer bought before and during Labor Week in previous years, e.g., 2020 and 2021. Specifically, for each year 2020 and 2021, the data sources 200 include customer purchases 202 30 days prior to the Labor Day 206 and customer purchases 204 during the Labor Day week. The data sources 202 and 204 are used to train an ML model 208 to predict whether a given consumer will make a purchase during the Labor Week of 2022.

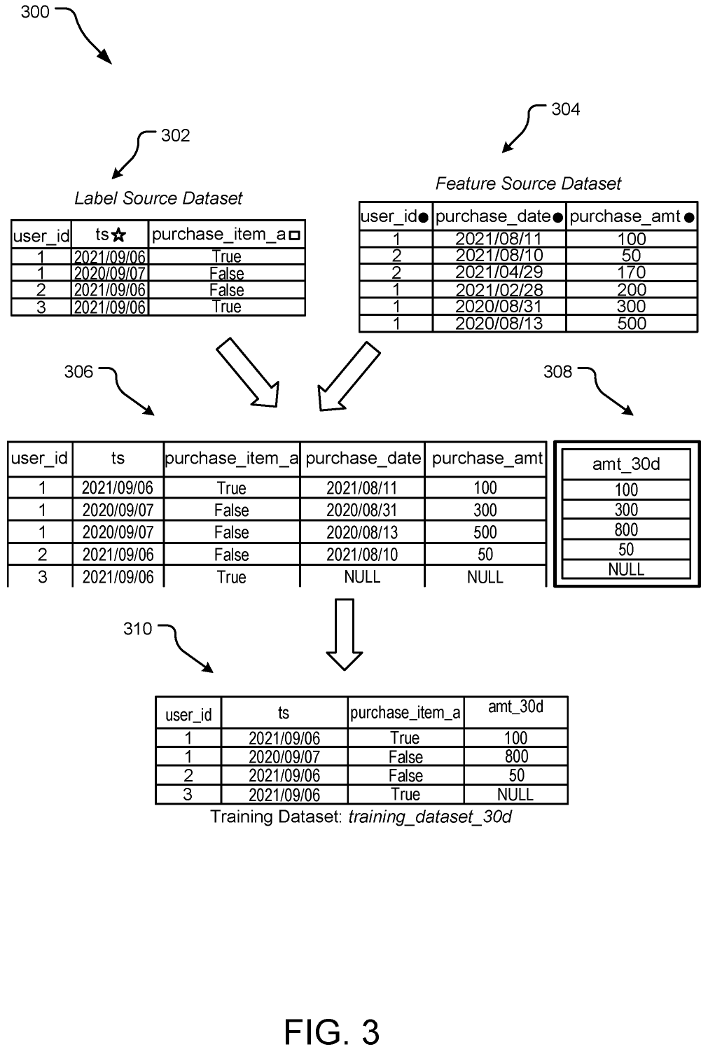

FIG. 3 illustrates a point-in-time (PIT) join 300 used to compute an aggregate feature according to the feature store data preparation optimization technology disclosed herein. Specifically, the PIT join 300 is a join between a label source dataset 302 and a feature source dataset 304 to generate output dataset 306. The PIT join 300 is a left-outer join, also referred to as a left-PIT join, that preserves all the data from the label source dataset 302.

For each record in label source dataset 302, the PIT join 300 matches records in feature source dataset 304 according to the correlated conditions in the WHERE clause and produces a single record per match corresponding to the greatest purchase_date that is less than or equal to ts. Note that the query preserves all records in the label source dataset 302 in the output dataset 306 even if there are no matches in the feature source dataset 304. In addition, this PIT join 300 computes a window aggregate feature amt_30d 308 containing the sum of purchase amounts over a 30 days. Here the condition purchase_date≤ts guarantees PIT correctness, while purchase_date≥ts-30 is relevant for the window aggregate feature amt_30 d 308. The output dataset 306 may be used to generate a training dataset 310 for a machine learning model.

FIG. 4 illustrates workflow 400 for feature extraction according to the feature store data preparation optimization technology disclosed herein. Specifically, the workflow 400 illustrates dataflow between components of an FS including an FS SDK 402, a feature catalog 406, and a compute engine 412 to one or more additional components of the FS data preparation optimization system disclosed herein.

A user, such as a data engineer or an AI algorithm, may define a feature using the FS SDK 402. For example, a data scientist may define a feature or a data pipeline as “a customer's average purchase price over 40 days.” Such feature definition is split across different components of the FS including the data sources of the FS, a transformations algorithm, an ML training engine using the output of the transformation, an ML inference engine using the trained ML model, etc.

A matcher engine 404 captures the new feature definition or pipeline defined by the user. The match engine 404 analyzes the new feature definition to determine one or more parameters or characteristics of the new feature. Thus, for example, the match engine 404 may determine that the newly defined feature is with respect to price paid by customer, and it is during the time period of the 40-day period of the new feature defined by the user. Subsequently, the match engine 404 analyzes the existing feature definitions or pipelines in the feature catalog 406 and retrieves various existing or computed feature definitions from the catalog store 406. Specifically, the match engine 404 retrieves various existing features that may match the newly defined feature by the user. For example, the match engine 404 may find that the feature catalog 406 includes an existing feature or pipeline for determining “total price paid by customers over 30 days” where the 30 days overlaps the first 30 days of the 40 days in the new feature definition by the user.

The existing features that may match the newly defined feature by the user together with the new feature definition are input into a feature rewriter 408. The feature rewriter 408 may analyze one or more precomputed feature dataset in view of the new feature definition and one or more parameters of the new feature definition to determine how the new feature definition should be executed. Such determination is made so that the execution of the new feature definition may benefit from the precomputed feature dataset. Based on such determination, the feature rewriter generates an alternative feature definition based on the new feature definition and the matched feature definitions. For example, the rewriter may define the alternative feature as ‘compute the average price paid by customer over 10 non-opverlapping days” and “append results to existing computed dataset.”

Subsequently, the alternative feature definition generated by the feature rewriter 408 and the new feature definition by the user into a cost estimator 410. The cost estimator 410 evaluates the new definition from the user and the alternative definition generated by the feature rewriter 408 and evaluates the cost of execution of a PIT join using the alternative feature definition and the cost of execution of a PIT join using the new feature definition. Based on the evaluation, the cost estimator 410 selects an execution alternative.

In one implementation, such selecting the execution alternative may include evaluating, using a feature selection criterion or a cost function, the execution of a PIT join using the alternative feature definition and the execution of a PIT join using the new feature definition. For example, the feature selection criterion or the cost function may include minimization of data to be scanned by the execution of a PIT join using the alternative feature definition and the execution of a PIT join using the new feature definition.

In one implementation, for a feature definition represented by a pipeline q having data source S_{q} of the size Dₛ and Sₚ being the partition strategy for the cost estimator 410 may estimate the cost of the pipeline q as:

$${C}_{q} = {\sum }_{s ∈ {S}_{q}} - {𝒟}_{s} - {𝒰}_{{s}_{p}}^{q} .$$

Here the cost estimator focuses on minimizing the cost of data scanned by the pipeline q as proxy for minimizing the cost. Here [symbol] is the benefit brought by Sₚ to the execution of q. The benefit is calculated as a weighted sum, in decreasing order of importance, of (a) the size of the data in the partitions in s that will not be read by q if the partitioning strategy p is used, (b) the size of the data filtered by q once it is read from the partitions selected, and (c) the number of partitions read, i.e., additional partitions add extra overhead during query planning and scheduling. In one implementation, the weighting coefficients are selected so that less significant terms only have relevance when more significant terms are equal.

The cost estimator 410 may iterate through the alternative feature definition and the new feature definition to determine cost of each of the alternative feature definition and the new feature definition. For example, the cost estimator 410 may calculate a benefit based on a number of data partitions to be read by the execution of a PIT join using the alternative feature definition and a number of data partitions to be read by the execution of a PIT join using the new feature definition. In one implementation, the minimization of data to be scanned may further include calculating a benefit based on a size of data not to be read by the execution of a PIT join using the alternative feature definition and a size of data not to be read by the execution of a PIT join using the new feature definition.

The selected execution alternative is subsequently provided to the compute engine 412, which executes the execution alternative. The FS SDK 402 registers the new feature and the alternative feature definition into the feature catalog 406.

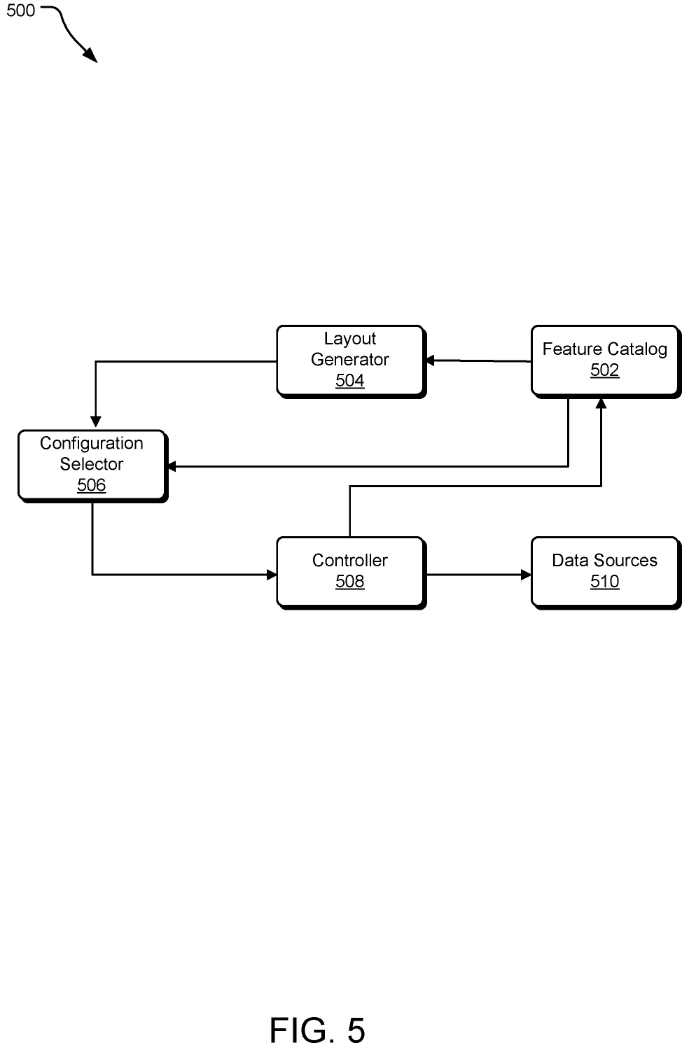

FIG. 5 illustrates workflow 500 for data layout selection according to the feature store data preparation optimization technology disclosed herein. Specifically, the workflow 500 illustrates dataflow between components of a feature catalog 502 and data sources 510 to one or more additional components of the FS data preparation optimization system disclosed herein.

The workflow 500 illustrates various data flows in response to periodic triggering of layout optimization. For example, such layout optimization may be triggered every hour, every day, etc. In response to such triggering, a layout generator 504 extracts feature definitions or pipelines from the feature catalog 502. Specifically, the layout generator may receive a number of candidate source data layouts that are based on current feature computation pipelines including PIT joins and current source data layout.

The layout generator 504 analyzes the extracted feature definitions to determine alternative data layouts. In one implementation, the layout generator 504 may retrieve the feature definitions from the feature catalog 502 and extract the data sources that were scanned to compute such features. Specifically, the layout generator 504 may extract data sources that (i) contain a time dimension t and (ii) are filtered by the value in t in the feature definition. Then, for each data source, the layout generator 504 may partition the data source into candidate data sources based on the expression f(t, e), where f is a flooring function by granularity e that is applied on the values of t, and e will take a different value, such as by month, day, hour, minute, etc., for each candidate data sources.

Subsequently, the candidate layouts are submitted to a configuration selector 506. Here the configuration selector may select a configuration of the data sources where different data sources are partitioned by different t, such as some data sources are partitioned by hour, some by minute, etc. Specifically, the configuration selector 506 makes a cost-based decision to select one of the candidate layout configuration. In one implementation, the configuration selector 506 may minimize cost Cw of a workload W using binary integer programming (BIP) using the following selection problem:

$$Minimize {𝒞}_{w} = {\sum }_{q ∈ W} {\sum }_{s ∈ {S}_{q}} {𝒟}_{s} - {\sum }_{p ∈ {P}_{s}} {x}_{{s}_{p}} \cdot {𝒰}_{{s}_{p}}^{q}$$

$$subject to {x}_{{s}_{p}} ∈ \{ 0 , 1 \} ∀ s ∈ {S}_{w , p} ∈ {P}_{s} \qquad ( 1 )$$

$${\sum }_{p ∈ {P}_{s}} {x}_{{s}_{p}} = 1 ∀ s ∈ {S}_{w} \qquad ( 2 )$$

$${\sum }_{s ∈ {S}_{w}} {\sum }_{p ∈ {P}_{s}} {D}_{s} \cdot ( 1 - {X}_{{s}_{p}}^{t - 1} ) \cdot {x}_{{s}_{p}} \leq ℬ \qquad ( 3 )$$

Here, given a workload W, s_{w} denotes the set of data sources read by pipeline in W. Further, given a data source s, Ps denotes the set of partition strategies generated for s by the candidate layout generator. For each strategy Sₚ, a variable xₛₚ denotes whether or not sp is part of selected configuration. Additionally, Xₛₚ^{t-1} refers to whether sp is part of the current configuration. Here B is the upper bound on the size of the data that can be rewritten. In one implementation, this bound is set based on several factors such as the duration of the time window for repartitioning and the performance of the compute engine.

In the above equation, constraint 1 states that each variable xₛₚ takes a value in {0,1}, constraint 2 ensures that exactly one partitioning strategy is chosen for a given source, and constraint 3 specifies that the size of the data sources that will be partitioned cannot exceed the upper bound B.

The selected data layout configuration is input to a controller 508 that implements the configuration on the data source 510 and registers the new configuration in the feature catalog 502. For example, such implementation of the selected configuration may result in partition of data by a different t.

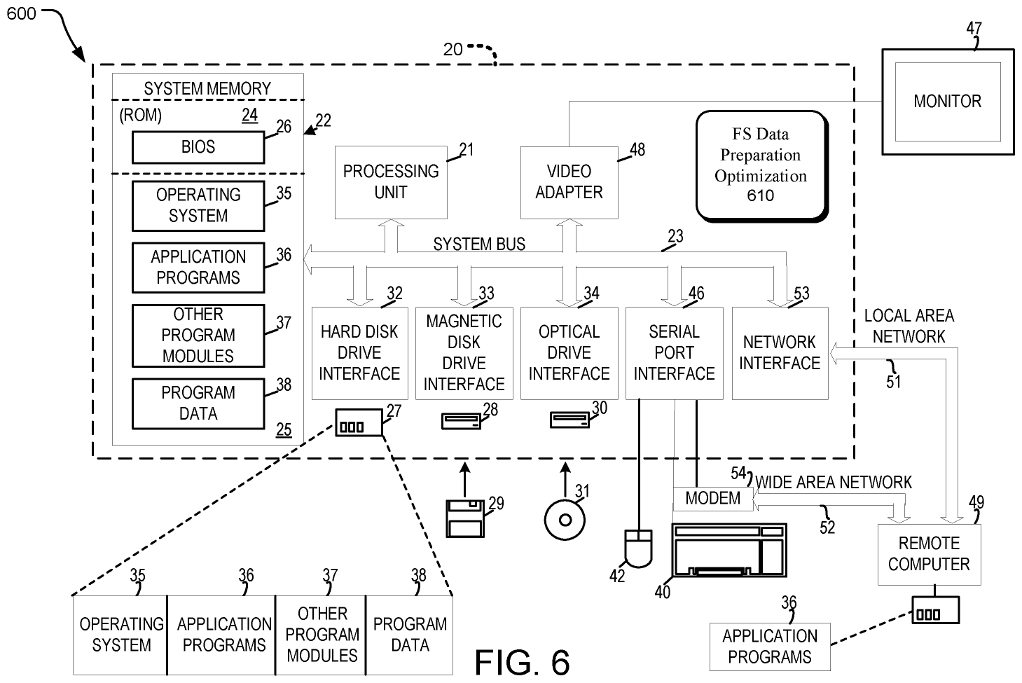

FIG. 6 illustrates an example system 600 that may be useful in implementing the high latency query optimization system disclosed herein. The example hardware and operating environment of FIG. 6 for implementing the described technology includes a computing device, such as a general-purpose computing device in the form of a computer 20, a mobile telephone, a personal data assistant (PDA), a tablet, smart watch, gaming remote, or other type of computing device. In the implementation of FIG. 6, for example, the computer 20 includes a processing unit 21, a system memory 22, and a system bus 23 that operatively couples various system components, including the system memory 22 to the processing unit 21. There may be only one or there may be more than one processing units 21, such that the processor of a computer 20 comprises a single central-processing unit (CPU), or a plurality of processing units, commonly referred to as a parallel processing environment. The computer 20 may be a conventional computer, a distributed computer, or any other type of computer; the implementations are not so limited.

The system bus 23 may be any of several types of bus structures, including a memory bus or memory controller, a peripheral bus, a switched fabric, point-to-point connections, and a local bus using any of a variety of bus architectures. The system memory 22 may also be referred to as simply the memory and includes read-only memory (ROM) 24 and random-access memory (RAM) 25. A basic input/output system (BIOS) 26, contains the basic routines that help to transfer information between elements within the computer 20, such as during start-up, is stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM, DVD, or other optical media.

The computer 20 may be used to implement a high latency query optimization system disclosed herein. In one implementation, a frequency unwrapping module, including instructions to unwrap frequencies based at least in part on the sampled reflected modulations signals, may be stored in memory of the computer 20, such as the read-only memory (ROM) 24 and random-access memory (RAM) 25.

Furthermore, instructions stored on the memory of the computer 20 may be used to generate a transformation matrix using one or more operations disclosed in FIG. 7. Similarly, instructions stored on the memory of the computer 20 may also be used to implement one or more operations of FIG. 1. The memory of the computer 20 may also one or more instructions to implement the high latency query optimization system disclosed herein.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated tangible computer-readable media provide non-volatile storage of computer-readable instructions, data structures, program modules and other data for the computer 20. It should be appreciated by those skilled in the art that any type of tangible computer-readable media may be used in the example operating environment.

A number of program modules may be stored on the hard disk, magnetic disk 29, optical disk 31, ROM 24, or RAM 25, including an operating system 35, one or more application programs 36, other program modules 37, and program data 38. A user may generate reminders on the personal computer 20 through input devices such as a keyboard 40 and pointing device 42. Other input devices (not shown) may include a microphone (e.g., for voice input), a camera (e.g., for a natural user interface (NUI)), a joystick, a game pad, a satellite dish, a scanner, or the like. These and other input devices are often connected to the processing unit 21 through a serial port interface 46 that is coupled to the system bus 23, but may be connected by other interfaces, such as a parallel port, game port, or a universal serial bus (USB). A monitor 47 or other type of display device is also connected to the system bus 23 via an interface, such as a video adapter 48. In addition to the monitor, computers typically include other peripheral output devices (not shown), such as speakers and printers.

The computer 20 may operate in a networked environment using logical connections to one or more remote computers, such as remote computer 49. These logical connections are achieved by a communication device coupled to or a part of the computer 20; the implementations are not limited to a particular type of communications device. The remote computer 49 may be another computer, a server, a router, a network PC, a client, a peer device, or other common network node, and typically includes many or all of the elements described above relative to the computer 20. The logical connections depicted in FIG. 8 include a local-area network (LAN) 51 and a wide-area network (WAN) 52. Such networking environments are commonplace in office networks, enterprise-wide computer networks, intranets, and the Internet, which are all types of networks.

When used in a LAN-networking environment, the computer 20 is connected to the local area network 51 through a network interface or adapter 53, which is one type of communications device. When used in a WAN-networking environment, the computer 20 typically includes a modem 54, a network adapter, a type of communications device, or any other type of communications device for establishing communications over the wide area network 52. The modem 54, which may be internal or external, is connected to the system bus 23 via the serial port interface 46. In a networked environment, program engines depicted relative to the personal computer 20, or portions thereof, may be stored in the remote memory storage device. It is appreciated that the network connections shown are example and other means of communications devices for establishing a communications link between the computers may be used.

In an example implementation, software, or firmware instructions for the feature store data preparation optimization system 610 may be stored in system memory 22 and/or storage devices 29 or 31 and processed by the processing unit 21. high latency query optimization system operations and data may be stored in system memory 22 and/or storage devices 29 or 31 as persistent data-stores.

In contrast to tangible computer-readable storage media, intangible computer-readable communication signals may embody computer readable instructions, data structures, program modules or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include wired media such as a wired network or direct-wired connection, and wireless media such as acoustic, RF, infrared and other wireless media.

Some embodiments of high latency query optimization system may comprise an article of manufacture. An article of manufacture may comprise a tangible storage medium to store logic. Examples of a storage medium may include one or more types of computer-readable storage media capable of storing electronic data, including volatile memory or non-volatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. In one embodiment, for example, an article of manufacture may store executable computer program instructions that, when executed by a computer, cause the computer to perform methods and/or operations in accordance with the described embodiments. The executable computer program instructions may include any suitable type of code, such as source code, compiled code, interpreted code, executable code, static code, dynamic code, and the like. The executable computer program instructions may be implemented according to a predefined computer language, manner, or syntax, for instructing a computer to perform a certain function. The instructions may be implemented using any suitable high-level, low-level, object-oriented, visual, compiled and/or interpreted programming language.

The high latency query optimization system disclosed herein may include a variety of tangible computer-readable storage media and intangible computer-readable communication signals. Tangible computer-readable storage can be embodied by any available media that can be accessed by the high latency query optimization system disclosed herein and includes both volatile and nonvolatile storage media, removable and non-removable storage media. Tangible computer-readable storage media excludes intangible and transitory communications signals and includes volatile and nonvolatile, removable, and non-removable storage media implemented in any method or technology for storage of information such as computer readable instructions, data structures, program modules or other data. Tangible computer-readable storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other tangible medium which can be used to store the desired information, and which can be accessed by the high latency query optimization system disclosed herein. In contrast to tangible computer-readable storage media, intangible computer-readable communication signals may embody computer readable instructions, data structures, program modules or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include signals moving through wired media such as a wired network or direct-wired connection, and signals moving through wireless media such as acoustic, RF, infrared and other wireless media.

An implementation disclosed herein provides a method including receiving a new feature definition; the new feature definition specifying parameters of the feature, comparing the new feature definition with a plurality of computed feature definitions stored in a feature store, in response to determining that the new feature definition is at least partially contained in a matched feature definition of the plurality of computed feature definitions, generating one or more alternative feature definitions based on the new feature definition and the matched feature definitions, and selecting an execution alternative from an execution of a PIT join using the alternative feature definition and an execution of a PIT join using the new feature definition.

In an alternative implementation, the system includes one or more physically manufactured computer-readable storage media, encoding computer-executable instructions for executing on a computer system a computer process, the computer process including receiving a new feature definition; the new feature definition specifying parameters of the feature, comparing the new feature definition with a plurality of computed feature definitions stored in a feature store, in response to determining that the new feature definition is at least partially contained in a matched feature definition of the plurality of computed feature definitions, generating an alternative feature definition based on the new feature definition and the matched feature definitions, and selecting an execution alternative from an execution of a PIT join using the alternative feature definition and an execution of a PIT join using the new feature definition, wherein selecting the execution alternative further comprises evaluating, using a feature selection criterion one or more of the alternative feature definitions and the new feature definition.

A system disclosed herein includes a memory, one or more processor units, and a feature store data preparation optimization system stored in the memory and executable by the one or more processor units, the service risk discovery system encoding computer-executable instructions on the memory for executing on the one or more processor units a computer process, the computer process including receiving a new feature definition; the new feature definition specifying parameters of the feature, comparing the new feature definition with a plurality of computed feature definitions stored in a feature store, in response to determining that the new feature definition is at least partially contained in a matched feature definition of the plurality of computed feature definitions, generating an alternative feature definition based on the new feature definition and the matched feature definitions, and selecting an execution alternative from an execution of a PIT join using the alternative feature definition and an execution of a PIT join using the new feature definition, wherein selecting the execution alternative further comprises evaluating, using a feature selection criterion one or more of the alternative feature definitions and the new feature definition.

The implementations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, dependent on the performance requirements of the computer system being utilized. Accordingly, the logical operations making up the implementations described herein are referred to variously as operations, steps, objects, or modules. Furthermore, it should be understood that logical operations may be performed in any order, unless explicitly claimed otherwise or a specific order is inherently necessitated by the claim language. The above specification, examples, and data, together with the attached appendices, provide a complete description of the structure and use of exemplary implementations.

What is claimed is:

1. A method, comprising:
receiving a new feature definition; the new feature definition specifying parameters of the feature;
comparing the new feature definition with a plurality of computed feature definitions stored in a feature store;
in response to determining that the new feature definition is at least partially contained in a matched feature definition of the plurality of computed feature definitions, generating one or more alternative feature definitions based on the new feature definition and the matched feature definitions; and
selecting an execution alternative from an execution of a PIT join using the alternative feature definition and an execution of a PIT join using the new feature definition.

2. The method of claim 1, further comprising:
receiving a plurality of candidate source data layouts that are based on current feature computation pipelines and current source data layout;
determining a plurality of candidate source data layouts; and
selecting a new data source layout from the plurality of candidate source data layouts that are based on current feature computation pipelines and current source data layout.

3. The method of claim 2, wherein selecting a new data source layout further comprising evaluating the plurality of candidate source data layouts and the current source data layout based on a layout selection criterion, wherein the layout selection criterion comprises selection of a minimum cost configuration of the new data source layout.

4. The method of claim 3, wherein the selection of the minimum cost configuration is implemented using binary integer programming.

5. The method of claim 1, wherein selecting the execution alternative further comprises evaluating, using a feature selection criterion one or more of the alternative feature definitions and the new feature definition.

6. The method of claim 5, wherein the feature selection criterion comprises minimization of data to be scanned using one or more of the alternative feature definitions and the new feature definition.

7. The method of claim 6, wherein the minimization of data to be scanned further comprises calculating a benefit based on a number of data partitions to be read by the execution of a PIT join using the alternative feature definition and a number of data partitions to be read by the execution of a PIT join using the new feature definition.

8. The method of claim 6, wherein the minimization of data to be scanned further comprises calculating a benefit based on a size of data not to be read by the execution of a PIT join using the alternative feature definition and a size of data not to be read by the execution of a PIT join using the new feature definition.

9. The method of claim 2, further comprising generating the plurality of candidate source data layouts further comprising:
retrieving the plurality of computed feature definitions stored in a feature store;
extracting data sources used to compute the plurality of computed feature definitions stored in a feature store; and
partitioning each of the extracted data sources based on a predetermined granularity of time period.

10. The method of claim 9, wherein the predetermined granularity of time period may be at least one of a month, a day, an hour, and a minute.

11. The method of claim 1, wherein the one or more computed feature definitions are determined using point-in-time joins.

12. One or more physically manufactured computer-readable storage media, encoding computer-executable instructions for executing on a computer system a computer process, the computer process comprising:
receiving a new feature definition; the new feature definition specifying parameters of the feature;
comparing the new feature definition with a plurality of computed feature definitions stored in a feature store;
in response to determining that the new feature definition is at least partially contained in a matched feature definition of the plurality of computed feature definitions, generating an alternative feature definition based on the new feature definition and the matched feature definitions; and
selecting an execution alternative from an execution of a PIT join using the alternative feature definition and an execution of a PIT join using the new feature definition,
wherein selecting the execution alternative further comprises evaluating, using a feature selection criterion one or more of the alternative feature definitions and the new feature definition.

13. The one or more physically manufactured computer-readable storage media of manufacture of claim 12, wherein the feature selection criterion comprises minimization of data to be scanned using one or more of the alternative feature definitions and the new feature definition.

14. The one or more physically manufactured computer-readable storage media of claim 13, wherein the minimization of data to be scanned further comprises calculating a benefit based on a number of data partitions to be read by the execution of a PIT join using the alternative feature definition and a number of data partitions to be read by the execution of a PIT join using the new feature definition.

15. The one or more physically manufactured computer-readable storage media of claim 13, wherein the minimization of data to be scanned further comprises calculating a benefit based on a size of data not to be read by the execution of a PIT join using the alternative feature definition and a size of data not to be read by the execution of a PIT join using the new feature definition.

16. The one or more physically manufactured computer-readable storage media of claim 12, wherein the computer process further comprising:
receiving a plurality of candidate source data layouts that are based on current feature computation pipelines and current source data layout;
determining a plurality of candidate source data layouts; and
selecting a new data source layout from the plurality of candidate source data layouts that are based on current feature computation pipelines and current source data layout.

17. The one or more physically manufactured computer-readable storage media of claim 16, wherein the computer process further comprising:
retrieving the plurality of computed feature definitions stored in a feature store;
extracting data sources used to compute the plurality of computed feature definitions stored in a feature store; and
partitioning each of the extracted data sources based on a predetermined granularity of time period.

18. A system comprising:
memory;
one or more processor units;
a feature store data preparation optimization system stored in the memory and executable by the one or more processor units, the service risk discovery system encoding computer-executable instructions on the memory for executing on the one or more processor units a computer process, the computer process comprising:
receiving a new feature definition; the new feature definition specifying parameters of the feature;
comparing the new feature definition with a plurality of computed feature definitions stored in a feature store;
in response to determining that the new feature definition is at least partially contained in a matched feature definition of the plurality of computed feature definitions, generating an alternative feature definition based on the new feature definition and the matched feature definitions; and
selecting an execution alternative from an execution of a PIT join using the alternative feature definition and an execution of a PIT join using the new feature definition,
wherein selecting the execution alternative further comprises evaluating, using a feature selection criterion one or more of the alternative feature definitions and the new feature definition.

19. The system of claim 18, wherein the computer instructions further comprising:
receiving a plurality of candidate source data layouts that are based on current feature computation pipelines and current source data layout;
determining a plurality of candidate source data layouts; and
selecting a new data source layout from the plurality of candidate source data layouts that are based on current feature computation pipelines and current source data layout.

20. The system of claim 19, wherein the computer instructions further comprising:
retrieving the plurality of computed feature definitions stored in a feature store;
extracting data sources used to compute the plurality of computed feature definitions stored in a feature store; and
partitioning each of the extracted data sources based on a predetermined granularity of time period.
